(19) United States
(12) Patent Application Publication
(10) Pub. No.: US 2001/0042812 A1
(43) Pub. Date: Nov. 22, 2001

(54) In-dash mount

(75) Inventor: Luke M. Perzewski, Stevens Point, WI (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: GAMBER JOHNSON LLC, Stevens Point, WI (US)

(21) Appl. No.: 09/859,476

(22) Filed: May 18, 2001

Related U.S. Application Data
(60) Provisional application No. 60/205,505, filed on May 19, 2000.

(51) Int. Cl. G12B 9/00

(52) U.S. Cl. 248/27.1

(57) ABSTRACT

An improved apparatus and method for the in-dash mounting and support of a personal computer, a display unit, a keyboard or other piece of similar electronic equipment in a motor vehicle which provides means for pivoting, sliding and locking the position of the bracket assembly and electronic equipment mounted thereto relative to a horizontal axis and a vertical axis. The invention improves the ability of a driver or passenger to adjust and maintain the relative orientation of in-dash mounted electronic equipment for improving the ease with which electronic equipment may be utilized.

### CROSS REFERENCE TO PROVISIONAL APPLICATION

This application claims the benefit to U.S. Provisional Patent Application No. 60/205,505 filed May, 19, 2000.

### BACKGROUND OF INVENTION

1. Field of Invention

The present invention relates generally to an apparatus and method for the in-dash mounting and support of a personal computer, a display unit, a keyboard or other piece of similar electronic equipment in a motor vehicle. More particularly, the invention relates to an apparatus and method for replacing a conventional in-dash ash tray or cup holder with a pivotable and slidable mounting assembly for the in-dash mounting and support of a personal computer, computer display, keyboard or other piece of similar electronic equipment while utilizing an existing in-dash bracket of an ash tray or cup holder.

2. Discussion of the Background

Various types of slidable in-dash ash trays and cup holders are well know in the prior art. Other prior art devices exist for adapting or converting an in-dash ash tray into a cup holder or for supporting a device, such as a rev counter, on-board computer or flashlight. For example, German Patent No. DE 3802801 to Ridder discloses an ash tray for a removable ash tray unit arranged in a housing detachably inserted into a dashboard of a vehicle, and a replacement housing corresponding to the ash tray housing including other equipment elements, such as a rev-counter or an on-board computer so that a motor vehicle may be retrofitted to meet the needs or smokers and non-smokers. U.S. Pat. No. 5,645,340 to Colton, discloses a flashlight assembly for insertion, storage and easy removal from an ashtray opening in a vehicle. Other patents, such as U.S. Pat. No. 4,953,772 to Phifer, discloses a drink holder which may be pivotably or slidably mounted in an ash tray or in an ash tray holding socket of a vehicle.

Various other patents, such as U.S. Pat. No. 4,983,951 to Igarashi et al., U.S. Pat. No. 5,161,028 to Kawata et al., U.S. Pat. No. 5,177,665 to Frank et al., U.S. Pat. No. 5,207,471 to Mutschler et al., U.S. Pat. No. 5,359,349 to Jambor et al., U.S. Pat. No. 5,822,023 to Suman et al., U.S. Pat. No. 6,011,685 to Otsuki, U.S. Pat. No. 6,012,785 to Kawasaki, and U.S. Pat. No. 6,181,387 to Rosen disclose pivoting and/or sliding in-vehicle mounting assemblies for display units, computers or other electronic devices. However, none of these patents, all of which are incorporated herein by reference, disclose a pivoting and sliding mounting assembly for replacement of an existing in-dash ash tray or cup holder which mounts to an in-dash bracket of an existing in-dash ash tray or cup holder. The present invention provides for an improved in-dash mounting bracket assembly for electronic equipment which provides means for pivoting and sliding the bracket assembly and electronic equipment mounted thereto relative to the horizontal and vertical axes for improving ability to adjust and maintain the orientation of in-dash mounted electronic equipment relative to the position of a driver or passenger for improving the ease with which electronic equipment may be utilized.

### SUMMARY OF THE INVENTION

Accordingly, it is a general object of the present invention to provide an improved apparatus and method for the in-dash mounting and support of a computer, a display unit and/or a keyboard or other electronic equipment. Another object of the invention is to provide an apparatus and method for pivotable and slidable in-dash mounting and support of a computer, a display unit and/or a keyboard which replaces of an in-dash ash tray or cup holder of a vehicle. It is yet a further object of the invention to provide for an apparatus and method for the pivotable and slidable in-dash mounting and support of a computer, a display unit and/or a keyboard which utilizes an existing dash bracket of a removed ash tray or cup holder.

### BRIEF DESCRIPTION OF THE DRAWINGS

FIG. 1 is a perspective view showing an in-dash ash tray/cup holder and dash bracket assembly in an open/extended position;

FIG. 2 is a perspective top side view showing an ash tray/cup holder removed from a dash bracket;

FIG. 3 is a perspective view of a backup plate, shelf bracket and dash bracket assembly of a preferred embodiment of the present invention;

FIG. 4 is a perspective view of a first preferred embodiment of the present invention mounting a display unit.

FIG. 5 is a perspective view of a second preferred embodiment of the present invention mounting a display unit and a keyboard.

### DESCRIPTION OF THE PREFERRED EMBODIMENTS

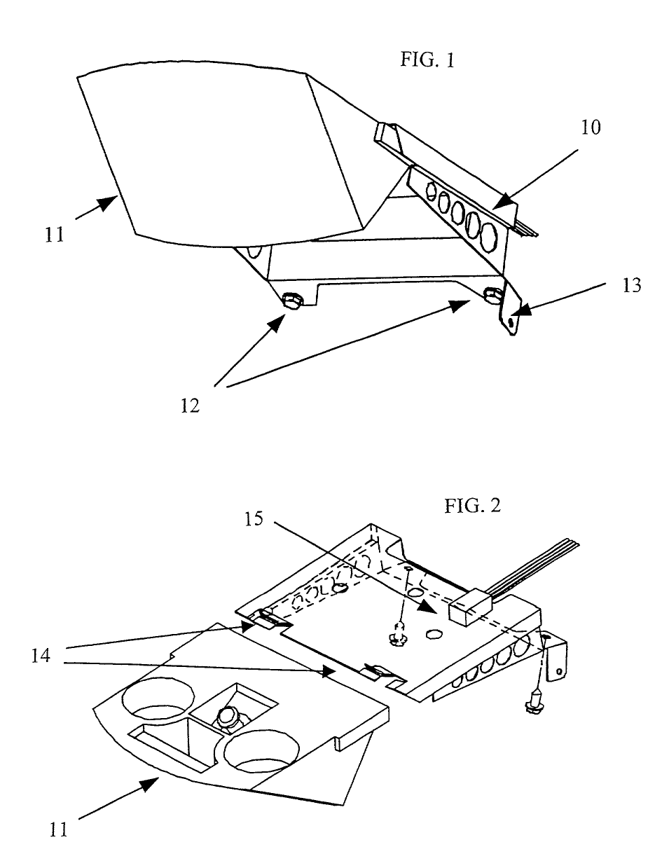

FIG. 1 shows a conventional in-dash ash tray/cup holder 11 and dash bracket 10 assembly in the open position. The dash bracket 10 holds the ash tray/cup holder 11 and is secured to the dash by screws 12. Dash bracket 10 is slidable forwards and backwards for storage within and extension from the dash of a vehicle. The dash bracket may include a carpet/mat attachment point 13

FIG. 2 shows a conventional ash tray/cup holder 11 removed from dash bracket 10. The ash tray/cup holder is held in position within the dash bracket 10 by spring clips 14. Removal of the ash tray/cup holder 11 from the dash bracket 10 may require the removing screws 12, disconnecting an electrical harness 15 or the like on the top side of the dash bracket 10, and bending the spring clips 21 upwardly.

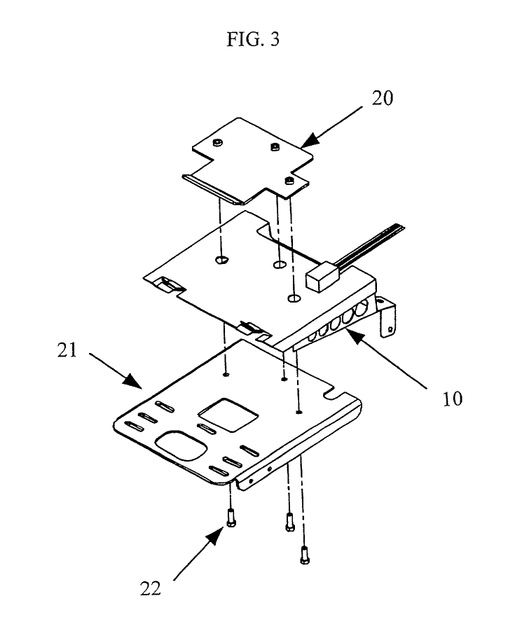

FIG. 3 shows a backup plate 20, shelf bracket 21 and dash bracket 10 of a preferred embodiment of the present invention prior to assembly. The backup plate 20 is disposed on the bottom side of the dash bracket 10. The shelf bracket 21 is disposed on the top side of the dash bracket 10. When assembled, the three pieces are fasted to one another by any suitable means, such as hex head screws 22.

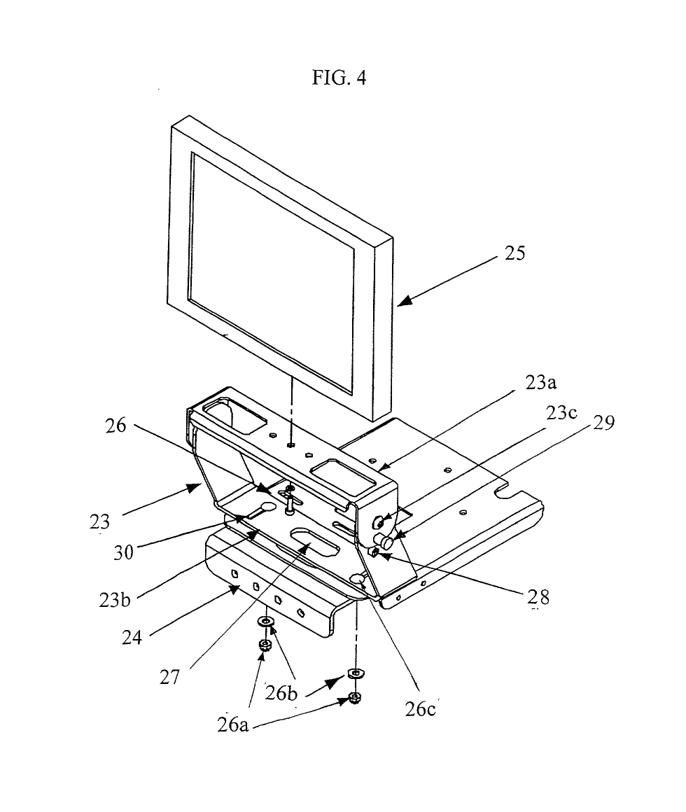

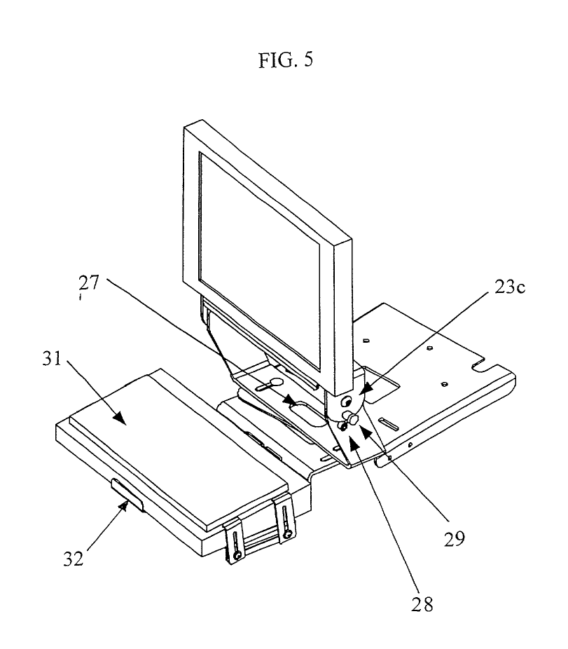

FIG. 4 shows a first preferred embodiment of the invention including a base and pivot assembly 23, a keyboard support bracket 24, display mounting hardware 26 for mounting a display 25. The base pivot assembly 23 includes an inverted generally u-shaped inverted top mounting bracket 23a, a generally u-shaped base mounting bracket 23b, and pivot adjustment screws 23c (only one being show). The display mounting hardware includes carriage bolts 26c, nuts 26a, and washers 26b. The base mounting bracket 23b includes a cable access opening 27. The base pivot assembly 23 may provide for means to limit the pivot travel distance, such as a travel limit screw 28, for limiting the range of rotation through which the top mounting bracket 23a may be rotated relative to the base mounting plate 23b. The base mounting plate 23b may include sliding slots 30 which provide means to slidably change the position of the base and pivot assembly relative to the shelf bracket 21 of FIG. 3. Further this preferred embodiment of the present invention includes a spring plunger 29 which provides means to lock the top mounting bracket 23a in position against pivoting rotation relative to the base mounting bracket 23b.

FIG. 5. shows a second preferred embodiment of the present invention additionally including a keyboard 30 and keyboard support 31 fastened to the keyboard support bracket 24 shown in FIG. 4.

The in-dash mounting apparatus and method of the present invention provides means for mounting various computers, display units and keyboards or the like to the dash of a motor vehicle or the like. A preferred embodiment of the invention provides means to convert a conventional in-dash ash tray/cup holder dash bracket assembly by attachment of a base and pivot assembly thereto for mounting and support of various computers, display units, or other electronic equipment while utilizing the existing dash bracket of a converted ash tray/cup holder. The second preferred embodiment of the invention includes an interface, cradle or docking station, to provide for a universal or custom designed keyboard support or tray for attaching a keyboard to the mounting surface. Other preferred embodiments of the invention may include means to limit the pivot travel distance of the top mounting bracket 23a in relation to the bottom mounting bracket 23b, such as a travel limit screw 28. Still further embodiments of the present invention include means to lock the relative pivot position of the top mounting bracket 23a in relation to the bottom mounting bracket 23b, such as a spring plunger 29.

Following removal of an existing in-dash ash tray/cup holder, a formed metal mounting surface, such as shelf bracket 21, is fastened to the in-dash bracket, either directly or with the use of a backup plate 20 secured through existing holes which previously held the ash tray/cup holder.

When installed, a preferred embodiment of the mounting apparatus of the present invention may extend out 3 to 4 inches from the vehicle dash to provide a horizontal surface having a pattern of slots or holes to which the base and pivot mounting assembly 23 attaches. Depending on the type and size of equipment to be mounted, an existing standard or custom designed interface attaches to at least one slot or hole of the pattern of slots and holes on the mounting surface, i.e. shelf bracket 21. In addition to securing the mounted equipment to the mount surface, a preferred embodiment of the subject invention may provide means for pivoting and/or sliding motion, i.e. tilt and/or swivel, of mounted electronic equipment in order to ease use of the equipment by the vehicle's driver or passenger(s).

While there has been shown and described the several preferred embodiments of the present invention, it will be evident to those skilled in the art that various modifications may be made thereto without departing from the spirit and scope of the invention as set forth in the appended claims.

What is claimed is:

1. An in-dash bracket assembly for pivotably and slidably mounting electronic equipment to a vehicle dash having a dash bracket which is forwardly slidable and rearwardly slidable relative to the vehicle dash, said bracket assembly comprising:
a shelf bracket, said shelf bracket being fastenable to the dash bracket and being forwardly and rearwardly slidable therewith; and
a base and pivot assembly fastened to said shelf bracket and being forwardly and rearwardly slidable therewith, said base pivot assembly comprising a substantially u-shaped base bracket slidably fastened to said shelf bracket and an inverted substantially u-shaped top bracket pivotably fastened to said base bracket and configured for mounting electronic equipment thereto.

2. A bracket assembly according to claim 1, said bracket assembly further comprising a backup plate, said backup plate being fastenable to the dash bracket and said shelf bracket, and being forwardly and rearwardly slidable therewith.

3. A bracket assembly according to claim 1, said base and pivot assembly further comprising a device for limiting a pivot travel distance of said top bracket relative to said base bracket.

4. A bracket assembly according to claim 1, said base and pivot assembly further comprising a device for locking a pivot position of said top bracket relative to said base bracket.

5. A bracket assembly according to claim 1, said base and pivot assembly further comprising a device for limiting a pivot travel distance of said top bracket and a device for locking a pivot position of said top bracket relative to said base bracket.

6. A bracket assembly according to claim 5, said base bracket further comprising an opening to access an electronic equipment cable.

7. A bracket assembly according to claim 1, said bracket assembly further comprising a second support bracket fastened to said shelf bracket and configured for mounting and supporting a keyboard.

8. Means for pivotably and slidably mounting electronic equipment to a dash of a vehicle having a dash bracket assembly which is forwardly slidable and rearwardly slidable relative to the vehicle dash, said mounting means comprising:
means for pivoting mounted electronic equipment relative to a horizontal axis;
means for sliding mounted electronic equipment relative to a vertical axis; and
means for forwardly sliding and rearwardly sliding mounted electronic equipment relative to the vehicle dash.

9. Means for pivotably and slidably mounting electronic equipment to a dash of a vehicle according to claim 8, said means for pivoting mounted electronic equipment further comprising means for limiting a pivot travel distance of mounted electronic equipment relative to a horizontal axis.

10. Means for pivotably and slidably mounting electronic equipment to a dash of a vehicle according to claim 8, said means for pivoting mounted electronic equipment further comprising means for locking a pivot position of mounted electronic equipment relative to a horizontal axis.

11. Means for pivotably and slidably mounting electronic equipment to a dash of a vehicle according to claim 10, said means for pivoting mounted electronic equipment further comprising means for limiting a pivot travel distance, and means for locking a pivot position of mounted electronic equipment.

12. Means for pivotably and slidably mounting electronic equipment to a dash of a vehicle according to claim 8, said bracket assembly further comprising means for accessing electronic equipment cables.

13. Means for pivotably and slidably mounting electronic equipment to a dash of a vehicle according to claim 8, said mounting means further comprising a second mounting means configured for mounting and supporting a keyboard.

14. An in-dash bracket assembly for pivotably and slidably mounting electronic equipment to a vehicle dash having a dash bracket which is forwardly slidable and rearwardly slidable relative to the vehicle dash, said bracket assembly comprising:
a shelf bracket having at least one sliding slot, said shelf bracket being fastenable to said dash bracket and being forwardly and rearwardly slidable therewith; and
a base and pivot assembly fastened to said shelf bracket and being forwardly and rearwardly slidable therewith, said base and pivot assembly comprising a substantially u-shaped base bracket slidably fastened to said shelf bracket and an inverted substantially u-shaped top bracket pivotably fastened to said base bracket and configured for mounting electronic equipment thereto.

15. A bracket assembly according to claim 14, said bracket assembly further comprising a backup plate, said backup plate being fastenable to said dash bracket and said shelf bracket, and being forwardly and rearwardly slidable therewith.

16. A bracket assembly according to claim 14, said base and pivot assembly further comprising an opening for accessing an electronic equipment cable.

17. A bracket assembly according to claim 14, further comprising a second support bracket fastened to said shelf bracket and configured for mounting and supporting a keyboard.

18. A method for mounting and supporting electrical equipment to a dash of a vehicle having a dash bracket which is forwardly slidable and rearwardly slidable relative to the dash, said mounting and supporting method comprising the steps of:
fastening a shelf bracket to said dash bracket;
slidably fastening a substantially u-shaped base bracket of a base and pivot assembly to said shelf bracket;
pivotably fastening an inverted substantially u-shaped top bracket of said base and pivot assembly to said base bracket; and
mounting electronic equipment to said top bracket.

19. A method for mounting and supporting electrical equipment to a dash of a vehicle according to claim 18, said method further comprising the step of:
fastening a backup plate to said dash bracket and said shelf bracket.

20. A method for mounting and supporting electrical equipment to a dash of a vehicle according to claim 18, said method further comprising the steps of:
fastening a second support bracket to said shelf bracket; and
mounting a keyboard to said second support bracket.
